(19) United States
(12) Patent Application Publication
(10) Pub. No.: US 2023/0324092 A1
(43) Pub. Date: Oct. 12, 2023

(54) OIL MANAGEMENT IN MULTI-COMPRESSOR SYSTEM

(71) Applicant: Carrier Corporation, Palm Beach Gardens, FL (US)

(72) Inventors: Ashalatha Kapa, Hyderabad (IN); Vinayak Rao Eluri, Hyderabad (IN); Srinivasa Reddy Pilli, Hyderabad (IN)

(21) Appl. No.: 18/194,850

(22) Filed: Apr. 3, 2023

Related U.S. Application Data
(60) Provisional application No. 63/328,373, filed on Apr. 7, 2022.

(51) Int. Cl. F25B 41/20; F25B 49/02; F25B 31/00

(52) U.S. Cl. CPC F25B 41/20; F25B 49/02; F25B 31/002

(57) ABSTRACT

A suction valve of a multiple-compressor heating ventilation and air conditioning (HVAC) system includes a valve housing including a valve inlet conduit to direct a flow of refrigerant from a heat absorption heat exchanger of the HVAC system into the suction valve, and a plurality of valve outlet conduits. Each valve outlet conduit of the plurality of valve outlet conduits is configured to direct the flow of refrigerant from the suction valve to a different compressor of the HVAC system. A valve seat is located in the valve housing. The valve seat has a plurality of valve passages extending therethrough. The valve seat is one or more of movable along a valve axis and rotatable about the valve axis to selectably direct the flow of refrigerant to one or more compressors of the HVAC system depending on a position of the valve seat in the valve housing.

### CROSS REFERENCE TO RELATED APPLICATIONS

This application claims the benefit of U.S. Provisional Application No. 63/328,373, filed Apr. 7, 2022, the disclosure of which is incorporated by reference in its entirety.

### BACKGROUND

Exemplary embodiments pertain to the art of heating, ventilation and air conditioning (HVAC) systems, and in particular to lubrication of compressors in multi-compressor HVAC systems.

In an HVAC system, to keep the compressors running properly it is important that adequate levels of lubricant such as oil are maintained in each of the compressors. Lubricant is typically entrained in the refrigerant flow through the system and returns to the compressors via the same suction inlet to the compressor through which the refrigerant passes. In some operating conditions, the level of oil in the compressors is uneven due to operating conditions in each of the compressors, and bends, turns and branching in the passages of a typical suction header leads to local stratification of the lubricant in the suction header and as such reduces the amount of lubricant returning to the compressors.

### BRIEF DESCRIPTION

In one embodiment, a suction valve of a multiple-compressor heating ventilation and air conditioning (HVAC) system includes a valve housing including a valve inlet conduit to direct a flow of refrigerant from a heat absorption heat exchanger of the HVAC system into the suction valve, and a plurality of valve outlet conduits. Each valve outlet conduit of the plurality of valve outlet conduits is configured to direct the flow of refrigerant from the suction valve to a different compressor of the HVAC system. A valve seat is located in the valve housing. The valve seat has a plurality of valve passages extending therethrough. The valve seat is one or more of movable along a valve axis and rotatable about the valve axis to selectably direct the flow of refrigerant to one or more compressors of the HVAC system depending on a position of the valve seat in the valve housing.

Additionally or alternatively, in this or other embodiments an actuator is operably connected to the valve seat to move the valve seat to a selected position in the valve housing.

Additionally or alternatively, in this or other embodiments the actuator is a stepper motor.

Additionally or alternatively, in this or other embodiments the valve seat includes a single valve port located at a first side of the valve seat, and a plurality of valve ports located at a second side of the valve seat opposite the first side. The plurality of valve passages extend from the single valve port to the plurality of valve ports.

Additionally or alternatively, in this or other embodiments the valve seat includes a first plurality of valve ports located at a first side of the valve seat, and a second plurality of valve ports located at a second side of the valve seat opposite the first side. The plurality of valve passages extend from the first plurality of valve ports to the second plurality of valve ports.

In another embodiment, a heating ventilation and air conditioning (HVAC) system includes a plurality of compressors arranged in a fluidly parallel relationship, a suction header to direct a flow a refrigerant to the plurality of compressors, and a suction valve located at the suction header. The suction valve includes a valve housing including a valve inlet conduit to direct a flow of refrigerant into the suction valve, and a plurality of valve outlet conduits. Each valve outlet conduit of the plurality of valve outlet conduits is configured to direct the flow of refrigerant from the suction valve to a different compressor of the plurality of compressors. A valve seat is located in the valve cylinder. The valve seat has a plurality of valve passages extending therethrough. The valve seat is one or more of movable along a valve axis and rotatable about the valve axis to selectably direct the flow of refrigerant to one or more compressors of plurality of compressors depending on a position of the valve seat in the valve housing.

Additionally or alternatively, in this or other embodiments a controller commands movement of the valve seat in the valve housing. The controller commands movement of valve seat based on detected load on the HVAC system and a detected oil circulation ratio through each compressor of the plurality of compressors.

Additionally or alternatively, in this or other embodiments one or more sensors at each compressor of the plurality of compressors determine the oil circulation ratio.

Additionally or alternatively, in this or other embodiments an actuator is operably connected to the valve seat to move the valve seat to a selected position in the valve housing.

Additionally or alternatively, in this or other embodiments the actuator is a stepper motor.

Additionally or alternatively, in this or other embodiments the valve seat includes a single valve port located at a first side of the valve seat, and a plurality of valve ports located at a second side of the valve seat opposite the first side. The plurality of valve passages extend from the single valve port to the plurality of valve ports.

Additionally or alternatively, in this or other embodiments the valve seat includes a first plurality of valve ports located at a first side of the valve seat, and a second plurality of valve ports located at a second side of the valve seat opposite the first side. The plurality of valve passages extend from the first plurality of valve ports to the second plurality of valve ports.

Additionally or alternatively, in this or other embodiments a heat rejection heat exchanger is fluidly connected to the plurality of compressors downstream of the plurality of compressors, an expansion device is fluidly connected to the heat rejection heat exchanger downstream of the heat rejection heat exchanger, and a heat absorption heat exchanger is fluidly connected to the expansion device downstream of the expansion device and upstream of the suction valve.

In yet another embodiment, a method of operating a suction valve of a heating ventilation and air conditioning (HVAC) system having a plurality of compressors includes determining a load condition of the HVAC system, and directing a flow of refrigerant to the suction valve. The suction valve includes a valve housing including a valve inlet conduit to direct a flow of refrigerant into the suction valve, and a plurality of valve outlet conduits. Each valve outlet conduit of the plurality of valve outlet conduits is configured to direct the flow of refrigerant from the suction valve to a different compressor of the plurality of compressors. A valve seat is located in the valve housing. The valve seat has a plurality of valve passages extending therethrough. The valve seat of the suction valve is moved to selectably direct the flow of refrigerant through one or more valve passages of plurality of valve passages to one or more compressors of the plurality of compressors based on the determined load condition of the HVAC system.

Additionally or alternatively, in this or other embodiments an oil circulation ratio in the flow of refrigerant of each compressor of the plurality of compressors is determined, and the determined oil circulation ratio is compared to a predetermined threshold. The valve seat is moved to selectably direct the flow of refrigerant to one or more compressors of the plurality of compressors at which the oil circulation ratio is below the predetermined threshold.

Additionally or alternatively, in this or other embodiments moving the valve seat includes one or more of moving the valve seat along a valve axis, or rotating the valve seat about the valve axis.

Additionally or alternatively, in this or other embodiments the valve seat is moved via operation of an actuator operably connected to the valve seat.

Additionally or alternatively, in this or other embodiments the actuator is a stepper motor.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a heating ventilation and air conditioning (HVAC) system;

FIG. 2 is a cross-sectional view of an embodiment of a suction valve of an HVAC system;

FIG. 3 is a cross-sectional view of the embodiment of FIG. 2 in a second position;

FIG. 4 is a cross-sectional view of the embodiment of FIG. 2 in a third position;

FIG. 5 is a cross-sectional view of the embodiment of FIG. 2 in a fourth position;

FIG. 6 is a cross-sectional view of another embodiment of a suction valve of an HVAC system;

FIG. 7 is a cross-sectional view of the embodiment of FIG. 6 in a second position;

FIG. 8 is a cross-sectional view of the embodiment of FIG. 6 in a third position;

FIG. 9 is a cross-sectional view of the embodiment of FIG. 6 in a fourth position;

FIG. 10 is a cross-sectional view of yet another embodiment of a suction valve of an HVAC system;

FIG. 11 is a cross-sectional view of the embodiment of FIG. 10 in a second position;

FIG. 12 is a cross-sectional view of the embodiment of FIG. 10 in a third position;

FIG. 13 is a cross-sectional view of the embodiment of FIG. 1—in a fourth position; and

FIG. 14 is a schematic illustration of a method of operating a suction valve of an HVAC system.

### DETAILED DESCRIPTION

A detailed description of one or more embodiments of the disclosed apparatus and method are presented herein by way of exemplification and not limitation with reference to the Figures.

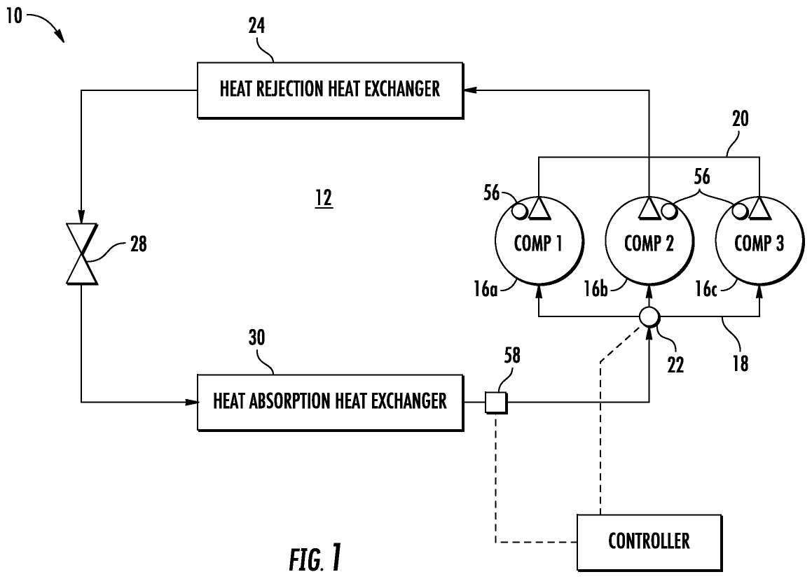

Referring to FIG. 1, illustrated is schematic of an embodiment of a heating, ventilation and air conditioning (HVAC) system 10. The HVAC system includes a refrigerant circuit 12 through which a flow of refrigerant 14 is circulated. The HVAC system 10 includes a plurality of compressors 16 arranged in a fluidly parallel configuration and connected to the refrigerant circuit by a suction header 18 and an outlet header 20. A suction valve 22 at the suction header 18 is operable to selectably direct the flow of refrigerant 14 to one or more of the compressors 16. The compressed flow of refrigerant 14 flows from the compressors 16 along the refrigerant circuit 12 to a heat rejection heat exchanger 24, also referred to as a condenser, then through an expansion device 28, such as an expansion valve, and through a heat absorption heat exchanger 30, also referred to as an evaporator. From the heat absorption heat exchanger 30, the flow of refrigerant 14 returns to the compressors 16 via the suction header 18 and the suction valve 22. While in the embodiment illustrated in FIG. 1 there are three compressors 16, one skilled in the art will readily appreciate that the present disclosure may be applied to HVAC systems 10 having other quantities of parallelly-arranged compressors 16, such as two, four or more compressors 16.

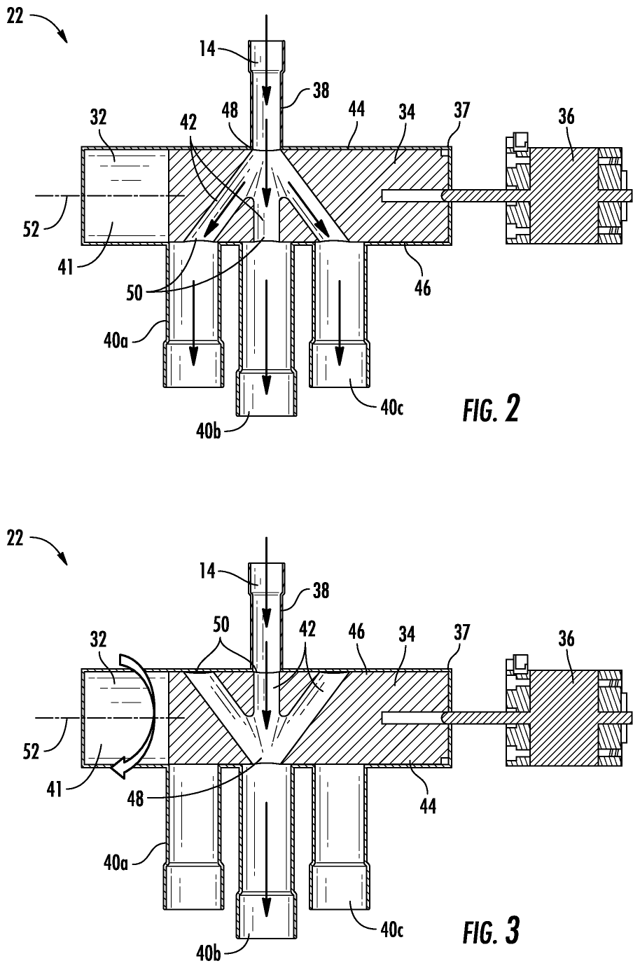

Referring to FIG. 2, illustrated is an embodiment of a suction valve 22. The suction valve 22 includes a valve housing 32 with a valve piston 34 located in the valve cylinder 32. The valve seat 34 is connected to an actuator 36, such as a stepper motor is operably coupled to the valve seat 34, to selectably move the valve seat 34 in the valve housing 32. While a stepper motor is disclosed and discussed herein, one skilled in the art will readily appreciate that other actuators 36 may be utilized to selectably move the valve seat 34 in the valve housing 32. In an embodiment, the valve housing 32 is generally cylindrical in shape. However, it should be understood that embodiments where the valve housing 32 is another suitable shape, such as a rectangle for example, are also within the scope of the disclosure.

The valve seat 34 is movably mounted within the hollow interior 41 of the valve housing 32. In the illustrated, non-limiting embodiment, the valve seat 34 is configured to translate along a valve axis 52 within the valve housing 32 to direct a flow of refrigerant to the one or more downstream compressors 16a, 16b, 16c. As shown, the valve axis 52 is oriented generally horizontally; however, it should be understood that in other embodiments the valve axis 52 may be arranged vertically, or at another position between horizontal and vertical. Embodiments where the valve seat 34 is movable in another manner, such as where the valve seat 34 is rotatable about the valve axis 52 within the valve housing 32 for example, are also within the scope of the disclosure.

A plurality of fluidly distinct ports are formed in the valve seat 34. In the illustrated, non-limiting embodiment, the valve housing 32 includes a valve inlet conduit 38 to admit the flow of refrigerant 14 from the heat absorption heat exchanger 30, and valve outlet conduits 40 to direct the flow of refrigerant 14 to each of the compressors 16. For example, in the embodiment of FIG. 2 the valve housing 32 includes a first valve outlet conduit 40a connected to first compressor 16a, a second valve outlet conduit 40b connected to second compressor 16b and a third valve outlet conduit 40c connected to third compressor 16c. Although the valve outlet conduits 40 are illustrated as being mounted at the same side or surface of the valve housing 32, embodiments where the valve outlet conduits 40 are mounted at different sides of the valve housing 32 are also contemplated herein. Further, the valve inlet conduits 38 may be mounted at the same side or at a different side of the valve housing 32 from the valve outlet conduits 40. The valve seat 34 is movably mounted within the hollow interior 41 of the valve housing 32 and includes a plurality of valve passages 42 extending from a first seat side 44 to a second seat side 46. In the embodiment of FIG. 2, the valve seat 34 includes a single first side port 48 at the first seat side 44 and three second side ports 50 at the second seat side 46. The three valve passages 42 each branch from the single first side port 48 to one of the three second side ports 50. In an embodiment, a seal, such as an O-ring for example, is arranged about the valve seat 34 adjacent opposing sides of each port 42, 50, to prevent leakage there between.

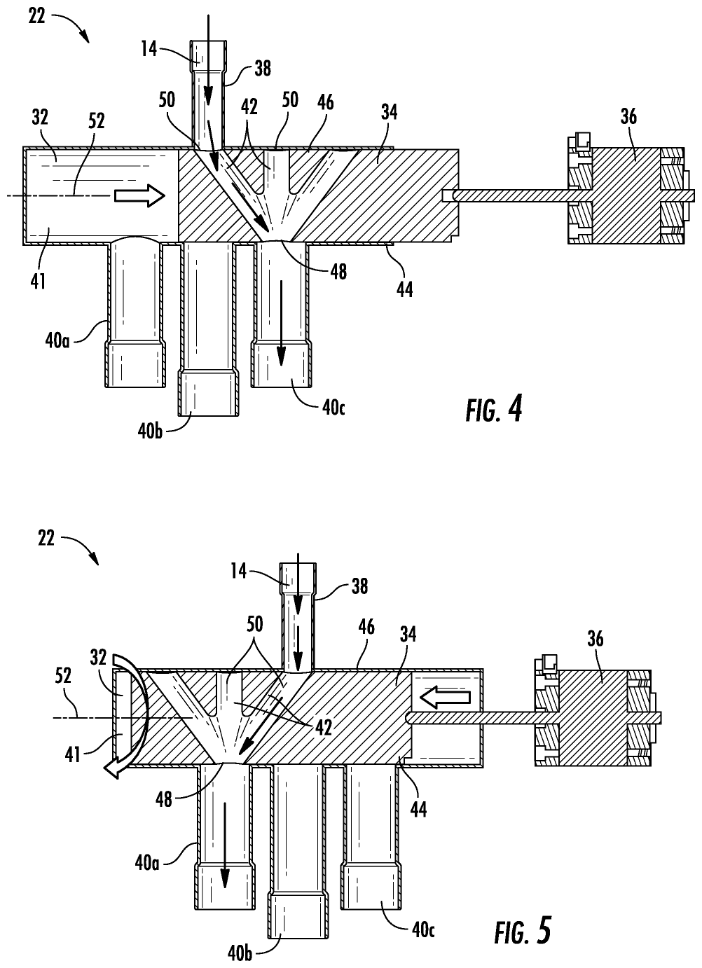

Operation of the suction valve 22 will now be described with reference to FIGS. 2-5, in which the valve seat 34 is movable between a plurality of positions. In FIG. 2, the suction valve 22 is in a first position. In the first position, the suction valve 22 directs the flow of refrigerant 14 from the heat absorption heat exchanger 30 to each of the compressors 16a, 16b, 16c. Referring to FIG. 3, the suction valve 22 is illustrated in a second position. To move from the first position to the second position, the actuator 36 is energized to rotate the valve seat 34 about the valve axis 52, such that the first seat side 44 is moved to be closest to the valve outlet conduits 40 of the valve housing 32 and the second seat side 46 is moved to be closest to the valve inlet conduit 38 of the valve housing 32. In the second position as shown, the flow of refrigerant 14 from the heat absorption heat exchanger 30 is directed only through the second valve outlet conduit 40b to the second compressor 16b. Referring now to FIG. 4, the suction valve 22 is illustrated in a third position. To move the suction valve 22 from the second position of FIG. 3 to the third position of FIG. 4, the actuator 36 is energized to move the valve seat 34 along the valve axis 52 in a first direction. In the third position as shown, the flow of refrigerant 14 is directed from the heat absorption heat exchanger 30 through only the third valve outlet conduit 40c toward the third compressor 16c. Referring now to FIG. 5, the suction valve 22 is illustrated in a fourth position. To move the suction valve 22 from either the second position or the third position to the fourth position, the valve seat 34 is moved by the actuator 36 along the valve axis 52 in a second direction opposite the first direction. In the fourth position as shown, the flow of refrigerant 14 is directed from the heat absorption heat exchanger 30 through only the first valve outlet port 40a toward the first compressor 16a.

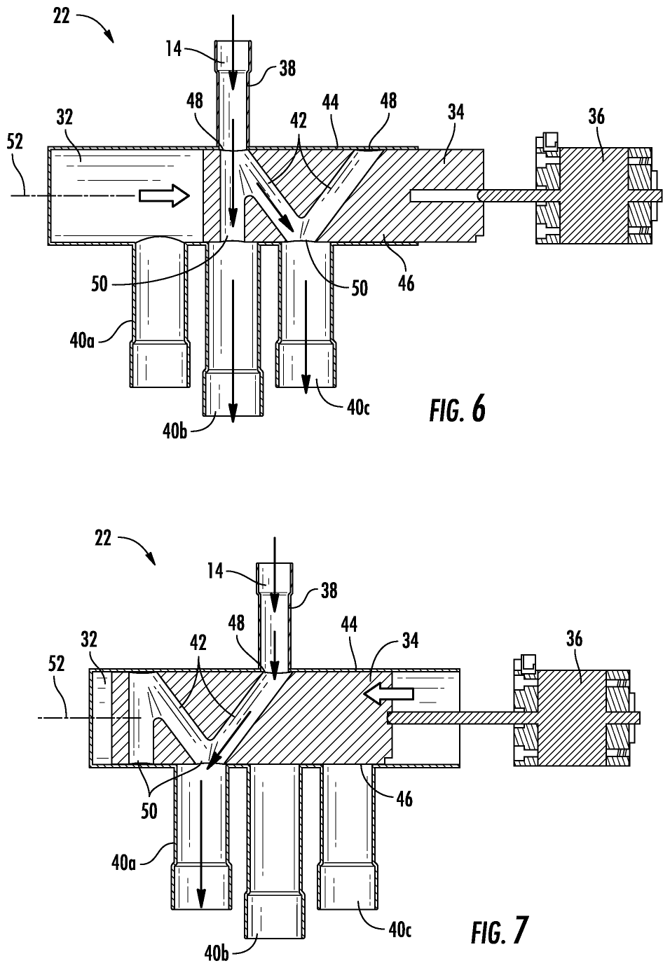

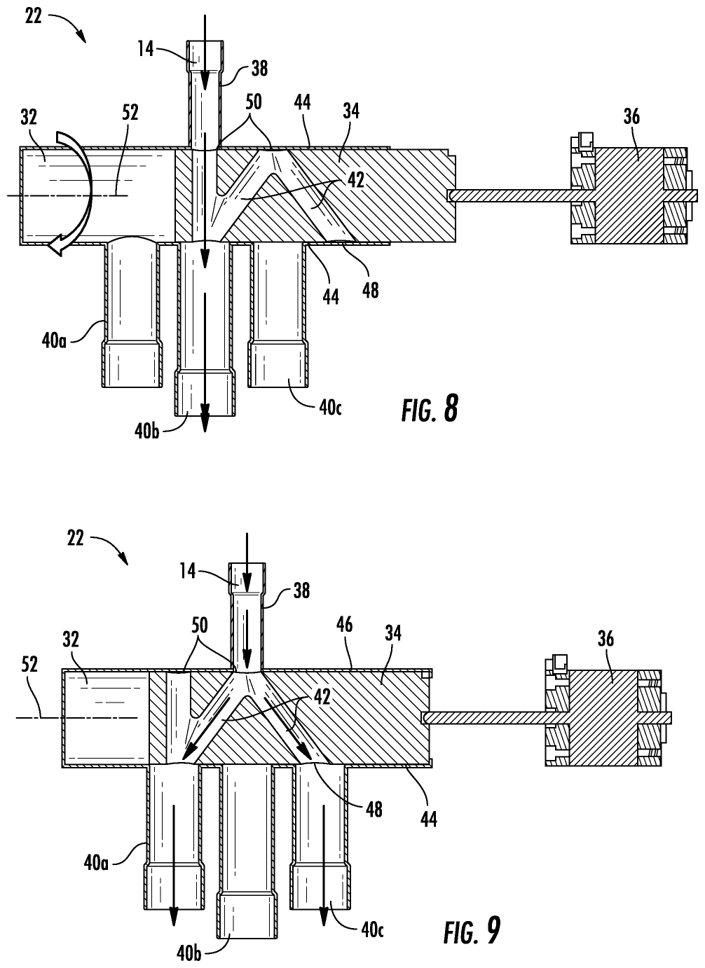

Another exemplary embodiment of a suction valve 22 is illustrated in FIG. 6. In this embodiment, the valve seat 34 has two first side ports 48 at the first seat side 44 and two second side ports 50 at the second seat side 46. Three valve passages 42 extend between the first seat side 44 and the second seat side 46. When the valve seat 34 is in a first position as shown in FIG. 6, the flow of refrigerant 14 from the heat absorption heat exchanger 30 is directed only through the second valve outlet conduit 40b and the third valve outlet conduit 40c to the second compressor 16b and the third compressor 16c. Referring now to FIG. 7, the valve seat 34 is illustrated in a second position, achieved by moving the valve seat 34 from the first position along the valve axis 52 in the second direction via operation of the actuator 36, the flow of refrigerant 14 from the heat absorption heat exchanger 30 is directed only through the first valve outlet conduit 40a to the first compressor 16a. Referring to FIG. 8, the valve seat 34 is illustrated in a third position. To move the valve seat 34 from the first position to the third position, the actuator 36 is activated to rotate the valve seat 34 about the valve axis 52, such that the first seat side 44 is moved to be closest to the valve outlet conduits 40 of the valve cylinder 32 and the second piston side 46 is moved to be closest to the valve inlet conduits 38 of the valve housing 32. When the valve seat 34 is in the third position, the flow of refrigerant 14 is directed only through the second valve outlet conduit 40b to the second compressor 16b. Referring to FIG. 9, the valve seat 34 is illustrated in a fourth position. To move the valve seat 34 from the third position to the fourth position, the actuator 36 is activated to move the valve seat 34 along the valve axis 52 in the second direction. When the valve seat 34 is in the fourth position, the flow of refrigerant 14 is directed only through the first valve outlet conduit 40a and the third valve outlet conduit 40c to the first compressor 16a and the third compressor 16c.

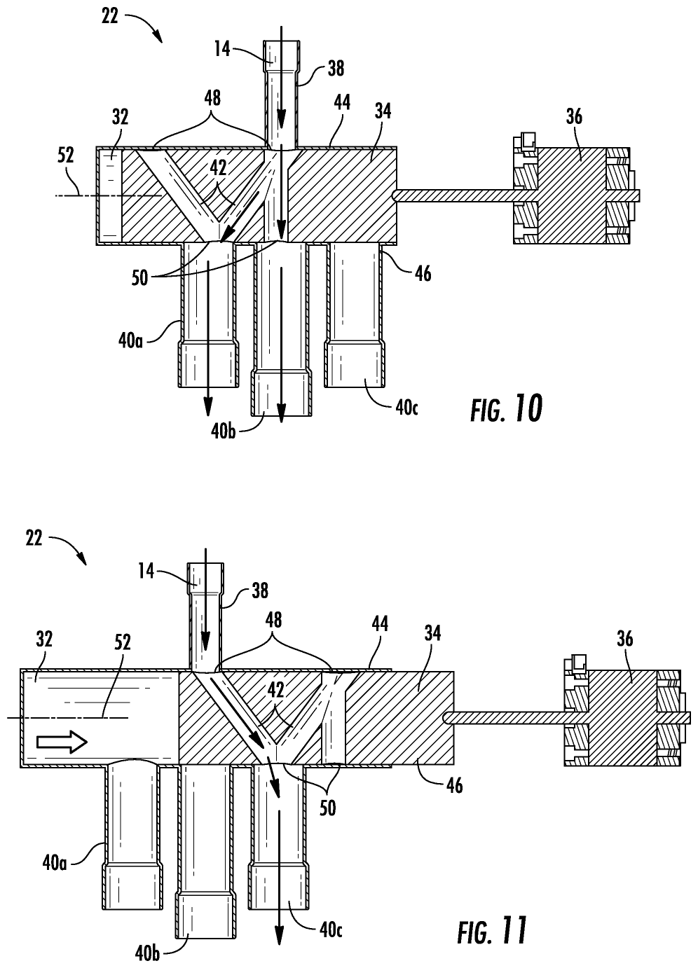

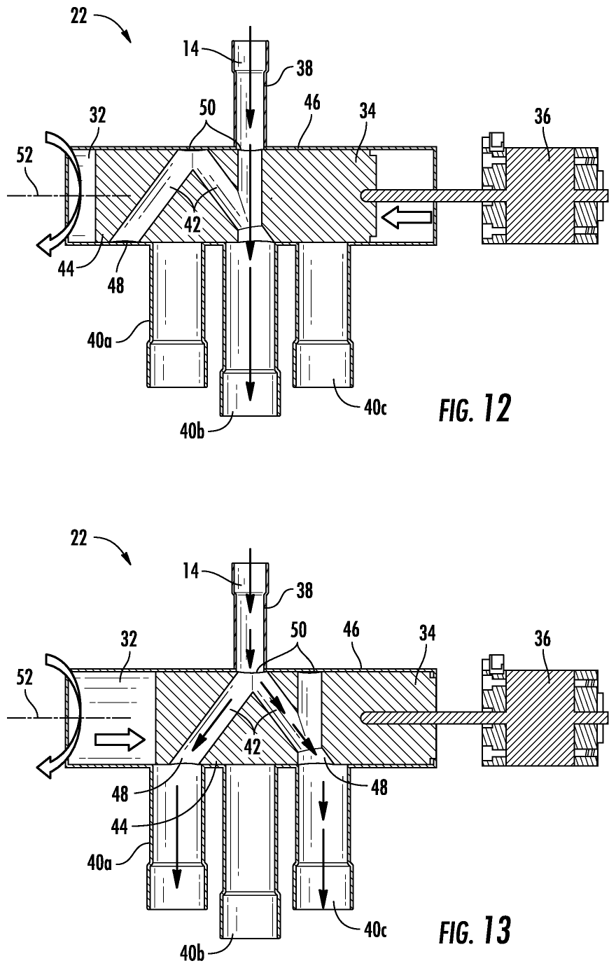

A third exemplary embodiment of suction valve 22 is illustrated in FIG. 10. In this embodiment, the valve seat 34 has two first side ports 48 at the first seat side 44 and two second side ports 50 at the second seat side 46. Three valve passages 42 extend between the first seat side 44 and the second seat side 46. When the valve seat 34 is in a first position as shown in FIG. 10, the flow of refrigerant 14 from the heat absorption heat exchanger 30 is directed only through the first valve outlet conduit 40a and second valve outlet conduit 40b to the first compressor 16a and second compressor 16b. The valve seat 34 is illustrated in a second position in FIG. 11. To move the valve seat 34 from the first position to the second position, the actuator 36 is activated to move the valve seat 34 along the valve axis 52 in the first direction. When the valve seat 34 is in the second position, the flow of refrigerant 14 from the heat absorption heat exchanger 30 is directed only through the third valve outlet conduit 40c toward the third compressor 16c. Referring now to FIG. 12, from the first position the actuator 36 rotates the valve seat 34 about the valve axis 52 to a third position. When the valve seat 34 is in the third position as shown in FIG. 12, the flow of refrigerant 14 is directed only through the second valve outlet conduit 40b to the second compressor 16b. Referring now to FIG. 13, from the third position the actuator 36 moves the valve seat 34 along the valve axis 52 in the first direction to a fourth position. In the fourth position, as shown in FIG. 13, the flow of refrigerant 14 is directed through only the first valve outlet conduit 40a and the third valve outlet conduit 40c to the first compressor 16a and the third compressor 16c.

In an embodiment, when the valve seat 34 is in any particular position, the valve seat 34 is arranged adjacent an end 37 of the valve housing 32 closest to the actuator 36. Accordingly, the first, second, third or fourth position may define the ends of the path of movement of the valve seat 34. In such embodiments, the maximum stroke of movement of the valve seat 34 may be defined between the first, second, third and fourth positions.

The end 37 of the valve housing 32 may be formed by a removable clip. During normal operation of the valve, movement of the valve seat 34 within the valve housing 32 is restricted by the clip. However, the clip may be separated from the valve housing 32 to provide access to and remove the valve seat 34 therefrom for service and/or maintenance.

Referring again to FIG. 1, the suction valve 22 is operably connected to a system controller 54 which operates the suction valve 22 based on HVAC system 10 load conditions, and modulated based on the different HVAC system 10 and compressor 166 operating conditions. Further, since the compressor lubricant is circulated with the flow of refrigerant 14, the suction valve 22 is modulated to maintain selected levels of lubricant circulation through each of the compressors 16a, 16b, 16c. When the one of the compressors 16a, 16b or 16c is not functioning due to some failure, the system controller 54 may be configured to automatically position the valve seat 34 in the respective required positions where the other compressors are active and the loading conditions.

In some embodiments, the system controller 54 monitors an oil circulation ratio (OCR), which is utilized to determine an amount of lubricant stratification in the compressors 16a, 16b, 16c, and adjusts the suction valve 22 accordingly to ensure an adequate supply of lubricant to each of the compressors 16a, 16b, 16c. In some embodiments, the OCR is monitored via lubricant pressure and temperature sensors 56 at each of the compressors 16a, 16b, 16c. Alternatively or additionally, the OCR is monitored more directly by OCR sensors 58 along the refrigerant circuit 12 corresponding to each of the compressors 16a, 16b, 16c.

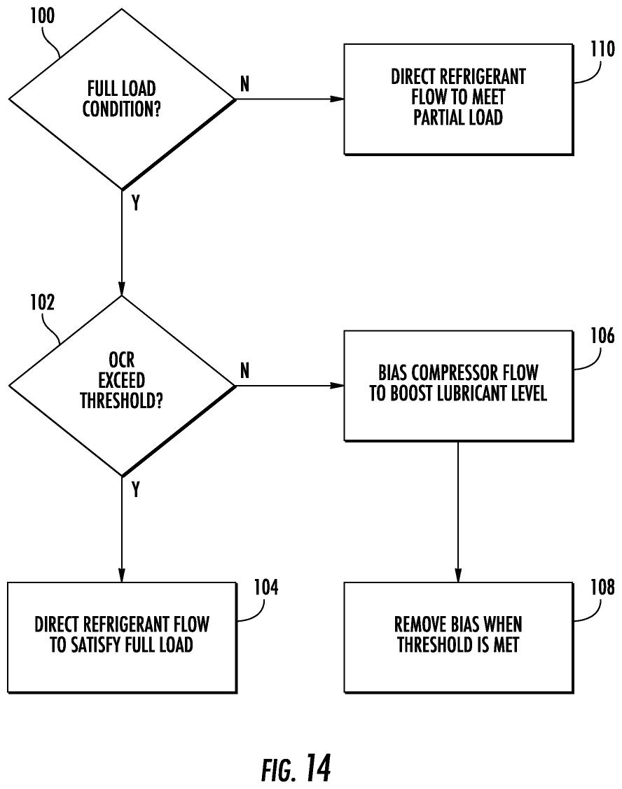

Referring now to FIG. 14, a method of operating the suction valve 22 is illustrated. At step 100, the system controller 54 determines a loading of the HVAC system 10, and if it is a full load condition. If it is a full load condition, the OCR for each of the compressors 16a, 16b, 16c is compared to a threshold OCR at block 102. If the OCR meets or exceeds the threshold for each of the compressors 16a, 16b, 16c, the suction valve 22 is operated at step 104 to direct the flow of refrigerant to all of compressors 16a, 16b, 16c. If, however, the OCR does not meet the threshold for one or more of the compressors 16a, 16b, 16c, the suction valve 22 is operated at step 106 to bias the flow of refrigerant 14 and entrained lubricant to the one or more compressors which do not meet the OCR threshold, in order to boost the level of lubricant in those compressors. At step 108, once the OCR threshold is achieved, the suction valve 22 is operated to direct the flow of refrigerant 14 to all of the compressors 16a, 16b, 16c. Alternatively, if the load condition is determined to be a partial load condition at step 100, the flow of refrigerant 14 is directed to one or more of the compressors 16a, 16b, 16c, based on the loading of HVAC system 10 at step 110.

The HVAC system 10 and the suction valve 22 allows for modulation of refrigerant flow 14 in a multi-compressor 16 HVAC system 10, and avoids oil stratification in the HVAC system 10 with the suction valve 22 configuration. With this configuration, only one suction valve 22 is required for the HVAC system 10, and allows for capacity adjustment through different displacements in the HVAC system 10. Further, the suction valve 22 allows for control of lubricant levels in the compressors 16 in a full load condition of the HVAC system 10. Further, by controlling the flow of oil to the compressors as needed, the life and energy efficiency of the system may be increased.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A suction valve of a multiple-compressor heating ventilation and air conditioning (HVAC) system, comprising:
a valve housing including:
a valve inlet conduit to direct a flow of refrigerant from a heat absorption heat exchanger of the HVAC system into the suction valve; and
a plurality of valve outlet conduits, each valve outlet conduit of the plurality of valve outlet conduits configured to direct the flow of refrigerant from the suction valve to a different compressor of the HVAC system;
a valve seat disposed in the valve housing, the valve seat having a plurality of valve passages extending therethrough;
wherein the valve seat is one or more of movable along a valve axis and rotatable about the valve axis to selectably direct the flow of refrigerant to one or more compressors of the HVAC system depending on a position of the valve seat in the valve housing.

2. The suction valve of claim 1, further comprising an actuator operably connected to the valve seat to move the valve seat to a selected position in the valve housing.

3. The suction valve of claim 2, wherein the actuator is a stepper motor.

4. The suction valve of claim 1, wherein the valve seat includes:
a single valve port located at a first side of the valve seat; and
a plurality of valve ports disposed at a second side of the valve seat opposite the first side;
wherein the plurality of valve passages extend from the single valve port to the plurality of valve ports.

5. The suction valve of claim 1, wherein the valve seat includes:
a first plurality of valve ports disposed at a first side of the valve seat; and
a second plurality of valve ports disposed at a second side of the valve seat opposite the first side;
wherein the plurality of valve passages extend from the first plurality of valve ports to the second plurality of valve ports.

6. A heating ventilation and air conditioning (HVAC) system, comprising:
a plurality of compressors arranged in a fluidly parallel relationship;
a suction header to direct a flow a refrigerant to the plurality of compressors; and
a suction valve disposed at the suction header, the suction valve including:
a valve housing including:
a valve inlet conduit to direct a flow of refrigerant into the suction valve; and
a plurality of valve outlet conduits, each valve outlet conduit of the plurality of valve outlet conduits configured to direct the flow of refrigerant from the suction valve to a different compressor of the plurality of compressors;
a valve seat disposed in the valve cylinder, the valve seat having a plurality of valve passages extending therethrough;
wherein the valve seat is one or more of movable along a valve axis and rotatable about the valve axis to selectably direct the flow of refrigerant to one or more compressors of plurality of compressors depending on a position of the valve seat in the valve housing.

7. The HVAC system of claim 6, comprising:
a controller to command movement of the valve seat in the valve housing;
wherein the controller commands movement of valve seat based on detected load on the HVAC system and a detected oil circulation ratio through each compressor of the plurality of compressors.

8. The HVAC system of claim 7, further comprising one or more sensors at each compressor of the plurality of compressors to determine the oil circulation ratio.

9. The HVAC system of claim 6, further comprising an actuator operably connected to the valve seat to move the valve seat to a selected position in the valve housing.

10. The HVAC system of claim 9, wherein the actuator is a stepper motor.

11. The HVAC system of claim 6, wherein the valve seat includes:
a single valve port located at a first side of the valve seat; and
a plurality of valve ports disposed at a second side of the valve seat opposite the first side;
wherein the plurality of valve passages extend from the single valve port to the plurality of valve ports.

12. The HVAC system of claim 6, wherein the valve seat includes:
a first plurality of valve ports disposed at a first side of the valve seat; and
a second plurality of valve ports disposed at a second side of the valve seat opposite the first side;
wherein the plurality of valve passages extend from the first plurality of valve ports to the second plurality of valve ports.

13. The HVAC system of claim 5, further comprising:
a heat rejection heat exchanger fluidly connected to the plurality of compressors downstream of the plurality of compressors;
an expansion device fluidly connected to the heat rejection heat exchanger downstream of the heat rejection heat exchanger; and
a heat absorption heat exchanger fluidly connected to the expansion device downstream of the expansion device and upstream of the suction valve.

14. A method of operating a suction valve of a heating ventilation and air conditioning (HVAC) system having a plurality of compressors, comprising:
determining a load condition of the HVAC system;
directing a flow of refrigerant to the suction valve, the suction valve including:
a valve housing including:
a valve inlet conduit to direct a flow of refrigerant into the suction valve; and
a plurality of valve outlet conduits, each valve outlet conduit of the plurality of valve outlet conduits configured to direct the flow of refrigerant from the suction valve to a different compressor of the plurality of compressors;
a valve seat disposed in the valve housing, the valve seat having a plurality of valve passages extending therethrough; and
moving the valve seat of the suction valve to selectably direct the flow of refrigerant through one or more valve passages of plurality of valve passages to one or more compressors of the plurality of compressors based on the determined load condition of the HVAC system.

15. The method of claim 14, further comprising:
determining an oil circulation ratio in the flow of refrigerant of each compressor of the plurality of compressors;
comparing the determined oil circulation ratio to a predetermined threshold; and
moving the valve seat to selectably direct the flow of refrigerant to one or more compressors of the plurality of compressors at which the oil circulation ratio is below the predetermined threshold.

16. The method of claim 14, wherein moving the valve seat includes one or more of:
moving the valve seat along a valve axis; or
rotating the valve seat about the valve axis.

17. The method of claim 14, wherein the valve seat is moved via operation of an actuator operably connected to the valve seat.

18. The method of claim 17, wherein the actuator is a stepper motor.
